(19) United States
(12) Patent Application Publication
(10) Pub. No.: US 2013/0298208 A1
(43) Pub. Date: Nov. 7, 2013

(54) SYSTEM FOR MOBILE SECURITY

(71) Applicant: Mourad Ben Ayed, Menlo Park, CA (US)

(72) Inventor: Mourad Ben Ayed, Menlo Park, CA (US)

(21) Appl. No.: 13/465,018

(22) Filed: May 6, 2012

(51) Int. Cl. G06F 21/00; H04B 7/00; H04L 27/00

(52) U.S. Cl. 726/6; 375/259

(57) ABSTRACT

A method and apparatus for mobile security using a short wireless device. The method and device increases mobile device security and data security and reduces false alerts.

### FIELD OF THE INVENTION

The present inventions relate to devices that allow automatic wireless authentication based on device proximity and more specifically relates to devices that provide intelligent login to applications and services.

### BACKGROUND

User authentication in computing systems traditionally depends on three factors: something you have (e.g., hardware token), something you are (e.g., a fingerprint), and something you know (e.g., a password). In this patent, we explore a new type of short wireless mobile device that performs all these factors and that is compatible with mobile devices.

Passwords remain the most common mechanism for user authentication in computer-security systems. Their various drawbacks, like poor selection by users and vulnerability to capture, are prompting a rapidly mounting adoption of hardware authentication tokens. Despite stronger security guarantees, though, hardware tokens share a limitation with passwords: inconsistent availability. Users frequently forget passwords. Similarly, they often lose, forget, and break their hardware tokens. As a result, a workable authentication system requires at least two modes of authentication. There is the primary mode of authentication, the password or token employed by the user in the normal course of events. Then there is the form of emergency authentication for cases when the primary authenticator is unavailable to a user.

Passwords and life questions are often categorized in the abstract as “something you know,” while hardware tokens are “something you have.” A third category of authenticator is “something you are,” that is, a biometric. Systems that authenticate users based on physical characteristics—particularly voice and fingerprints—are enjoying ever-rising popularity.

The general consensus of the security community, however, is that biometrics is not suitable as primary authenticators. Biometrics are often not secret. People publicly expose their voices and fingers in various ways on a regular basis, creating the possibility of biometric spoofing.

Users generally don't forget or lose their biometrics permanently—but chapped fingers and laryngitis can lead to temporary loss.

Patent application Ser. No. 12/488,611 by the current inventor describes a System for Wireless Authentication Based on BLUETOOTH Proximity.

Although this application teaches automatic login, it does not describes intelligent login that minimizes the user entering PIN codes or passwords.
U.S. Pat. No. 7,973,657 by the current inventor titled System For Monitoring Proximity To Prevent Loss Or To Assist Recovery teaches a BLUETOOTH keychain with a proximity alarm, a headset function and that sends data for login. The current patent does not teach intelligent login that minimizes the user entering PIN codes or passwords.
U.S. Pat. No. 7,664,463 by the current inventor titled Portable Loss Prevention System describes a BLUETOOTH loss prevention system. The described system does not provide automatic login and single logon functionality.

U.S. patent application Ser. No. 12/177,495 by Ketari et al. describes a Proximity Access and Alarm Apparatus that uses a proximity device. Ketari does not describe intelligent login. Similarly, patent application Ser. Nos. by Ketari 12/203,049, 12/17752, 12/198,218 and 12/488,611 describe BLUETOOTH access and proximity alarm devices with no intelligent login function.

Portable electronic devices such as cellular telephones, personal digital assistants (PDAs), wireless email devices, instant messaging devices, pagers, portable compact disk (CD) players, portable MP3 players, and others are often forgotten, lost, or stolen (a “PED” includes any portable device that can be used for communication, performing intellectual and/or physical work, and/or entertainment). Existing wireless device loss detection approaches focus primarily on remotely accessing a device after it is lost. This allows prohibiting the device, such as a cell phone, from placing phone calls. It also allows hiding the device owner's information or erasure of sensitive data. This strategy aims to increase the user's chances of recovering the device and to protect data stored in the device. This method does not allow users to quickly recover their lost devices.

Other methods for tracking and locating a lost cell phone include network triangulation and GPS interrogation. These methods do not allow users to automatically and/or instantaneously recover their lost devices.

The most common model for PC application login generally relies on a set of user name and password that the user enters in a login screen. Once the user name and login are authenticated, the user gains access to the application.

This model has presents a few security problems. For example:

Multiple users can login with the same username/password,

A person can steal a username and password combination without the account owner noticing. The person can login into the system undetected.

For mobile phone applications, the phone generally goes to sleep mode after one minute of user inaction, and later, the user has to login again. For frequent users of mobile applications, this process is inconvenient and wastes them a lot of time. The current invention utilizes features of BLUETOOTH to provide secure automatic access to mobile payment, mobile banking and mobile CRM applications thus increasing usability, convenience and efficiency to users while maintaining higher security standards. This new technology also provides an alarm when the user mobile terminal is away from the device of the invention, thus preventing loss and theft of mobile terminals.

Another method and apparatus for reducing the likelihood of losing a portable electronic device is disclosed in U.S. Pat. No. 6,836,212 by Sawinski et al. titled Method and apparatus for reducing the likelihood of losing a portable electronic device and similarly in U.S. Pat. No. 7,005,999 by Salzhauer et al. titled Personal monitoring system.

These two inventions monitor inadvertent removal of a portable electronic device (PED) from its retaining device. So, if the PED is already removed from its retaining device for use or the retaining device and PED are left behind together or move out of a desired range, this apparatus does not protect users from losing their PEDS.

US patent application publication 20050280546 by Ganley et al. titled Proximity aware personal alert system discloses two mobile transceivers that are linked through a BLUETOOTH link. The BLUETOOTH enabled RF link between the first and second mobile transceiver units forms a monitoring piconet. The second mobile transceiver unit provides an alarm indication when the first mobile transceiver unit moves beyond a distance of approximately ten meters from the second mobile transceiver unit. The second device repeatedly pages the first device, and waits for a response. If a response is not received, an alarm is issued. This system does not use sleep modes effectively. It uses paging which consumes 40 mA, a rate that would inconvenience the user by requiring an expensive and/or heavy battery or frequent recharging. The system of the current invention relies on HFP or SPP link, and alerts on link drop.

Ganley teaches a two part system, whereas the current invention teaches a unitary system. Ganley does not teach a system for getting login parameters from a BLUETOOTH device and automatically logging the user to an application.

U.S. Pat. No. 6,989,748 by Rabanne et al. titled Battery with integrated tracking device discloses a battery with an integrated tracking device. The system is difficult to commercialize because of the large variety of batteries on the market. Furthermore, the transmitter/receiver system needs an antenna, and it would be a challenge to install an antenna inside the battery or on its surface as that would compromise its performance. This system also does not provide phone automatic login to applications functionality.

U.S. Pat. No. 5,796,338 by Mardirossian et al. titled System for preventing loss of cellular phone or the like discloses a system and method for preventing loss of a cellular phone or similar portable device. The system includes a wireless transmitter in cell phones for intermittently sending security signals to a pager worn by the user. An alarm is actuated when the strength of the security signal falls below a predetermined threshold. This system cannot be used with existing phones and requires cell phone manufacturers to modify their designs. This system also does not provide automatic login functionality.

U.S. Pat. No. 7,340,215 by Yokoshi et al. titled Communication system, communication terminal apparatus and wireless key apparatus discloses a method for restricting the operation of a mobile terminal when a connection with a BLUETOOTH key is not established. This system cannot be used with market-ready phones and requires cell phone manufacturers to modify their designs. This system also does not provide automatic login functionality.

US patent Application 2006/0083187 by Dekel et al. titled Pairing system and method for wirelessly connecting communication devices discloses a method for establishing a communication connection with a target device over a short-range wireless communication protocol, pairing with a device and forwarding the pairing request to a destination address over a wide area network. Dekel does not teach to alarm on loss of mobile device, or to provide automatic login function.

U.S. Pat. No. 7,054,595 by Bloch et al titled Data security device discloses a backup device having memory and a wireless communication link. The backup device communicates periodically with a mobile device and may backup data. An alarm is activated to alert a user to loss of the mobile phone if the mobile phone is out of communication for a predetermined period.

Bloch does not teach automatic login to mobile applications. Bloch also does not teach API to integrate communication with BLUETOOTH device functionality into an application.

U.S. Pat. No. 7,463,861 and US patent applications 20090093215 and 20060199538 by Eisenbach et al. titled Automatic data encryption and access control based on BLUETOOTH device proximity teaches a method and apparatus for securing sensitive data on a secured BLUETOOTH device whereby when contact is lost, sensitive data is automatically encrypted, and when contact is restored, the data is automatically decrypted.

The inventor has several patents and applications on the matter:

US patent application 20090047903 by the same inventor titled Automatic resource availability using BLUETOOTH teaches a method for designating trusted devices, and designating files as shareable. When in proximity to a trusted device, shareable files may be accessed securely.

US patent application 20060199536 by the same inventor titled Automatic network and device configuration for handheld devices based on BLUETOOTH device proximity teaches a method for automatically using the lowest cost connection from the available set of paired devices that are in proximity with the BLUETOOTH handheld device.
These systems do not provide secure automatic login to applications and does not alarm when a mobile device is lost.

U.S. Pat. No. 7,526,295 by Khare et al. titled Integration of secure identification logic into cell phone teaches a method for generating a password based on a seed and synchronization time, and displaying the password on a mobile phone display. The user can use the password to access a network. The current prior art does not disclose a method or apparatus for proximity alarming or automatic login to an application.

U.S. Pat. No. 7,378,939 by Sengupta et al. titled Method and apparatus for providing proximity based authentication, security, and notification in a wireless system teaches a method for automatically locking a mobile device when an authentication device is not within proximity, while keeping the user logged in, wherein a locked device cannot be used by anyone and an unlocked device can be used by the user. Sengupta invention teaches logging user to the wireless mobile device, i.e. at the operating system level, and not to an application running on said device. Sengupta invention does not teach an API that can integrate automatic login function into an application. It does not send the password to a RADIUS server. Furthermore, Sengupta system does not alarm when the mobile phone is lost or stolen.

U.S. Pat. No. 6,577,239 by Jespersen et al. titled Electronic apparatus including a device for preventing loss or theft also teaches a control device for sending an enabling signal to a mobile phone. The enabling signal enables operation of the mobile phone. If the mobile phone is no longer able to receive the enabling signal, then it is disabled. This patent does not teach a method for automatic login to an application.

U.S. Pat. No. 7,076,238 by Matsumoto et al. titled Wireless communication system exchanging encrypted data teaches a method for encrypting data and transmitting it to an electronic device together with a decrypting key. The current prior art does not disclose a method or apparatus for proximity alarming or automatic login to an application. The current prior art does not disclose a method or apparatus for proximity alarming or automatic login to an application that runs onboard the mobile phone.

U.S. Pat. No. 7,069,001 by Rupp et al. titled Method for supporting cashless payment teaches a method for authorizing payment transactions using a mobile phone. Rupp does not teach using an electronic device together with the mobile phone.

U.S. Pat. No. 7,106,171 by Burgess et al. titled Keyless command system for vehicles and other applications teaches a wireless remote-control transmitter with keypad for entering an identification code so that only an authorized operator can use the device. The described system does not provide automatic locking and unlocking for vehicles based on BLUETOOTH proximity.

Thus, a need exists for systems for monitoring mobile phones and for providing automatic login functionality to applications, automatic screen unlocking functionality, and automatic user authentication for transaction processing. Such systems should provide an alarm to users upon detecting that a phone is not within a desired proximity, wherein the alarm is appropriate to the circumstances. Further, there is also a need for more automatic login to applications and services while reducing the risk of loss and unauthorized access, and to make such systems ubiquitous as standard accessories.

### SUMMARY OF THE INVENTION

A method for mobile security comprising: a computer terminal establishing a short wireless connection with a paired unitary mobile apparatus, wherein said unitary mobile apparatus has a volume smaller than 30 cm³, a memory smaller than 100 Mega Bytes, and does not have an LCD larger than 3 cm2; wherein upon said computer terminal sending at least one digital code wirelessly to said paired unitary mobile apparatus using a data communication protocol selected from the group consisting of: Serial Port Profile (SPP), iPod Accessory Protocol (iAP) and NFC, wherein said at least one digital code indicating to activate proximity monitoring, said unitary mobile apparatus monitors proximity to said computer terminal using a communication protocol selected from the group consisting of: Hands Free Profile (HFP), Headset Profile (HSP), Human Interface Device Profile (HID), Advanced Audio Distribution Profile (A2DP), wherein upon detection of an event selected from the group consisting of: said short wireless connection dropped due to a loss of signal, said short wireless connection has signal strength that is below a predetermined threshold, said unitary mobile apparatus performs actions selected from the group consisting of: issuing an audible alert and issuing a vibration indication; wherein upon said computer terminal sending at least one digital code wirelessly to said paired unitary mobile apparatus, wherein said at least one digital code indicating to deactivate proximity monitoring, said unitary mobile apparatus stops indicating events corresponding to loss of proximity.

A unitary mobile apparatus for providing user authentication information comprising: a single short wireless transceiver, wherein said short wireless transceiver is selected from the group consisting of: Bluetooth, Wibree, NFC, ANT, Wi-Fi; an onboard memory for storing at least one user key; an onboard motion detector means for determining if the user is moving; wherein said unitary mobile apparatus establishes a short wireless connection with a paired computer terminal within proximity; wherein upon receipt of a wireless request for a user digital key from said paired computer terminal within proximity, performing actions selected from the group consisting of: verifying that the user is not moving using said onboard motion detector means, and verifying that the user motion patterns from said onboard motion detector means has a high correlation with a predetermined idle motion pattern; if the user is not moving, sending the at least one user digital key from memory to said paired computer terminal wirelessly, if the user is moving, said unitary mobile apparatus does not send a response; wherein said unitary mobile apparatus has a volume smaller than 30 cm³, has a memory smaller than 100 Mega Bytes, and does not have a display larger than 3 CM2.

A method for security comprising: a unitary mobile apparatus establishing a short wireless connection with a paired computer terminal, wherein said unitary mobile apparatus has a volume smaller than 30 cm³, a memory smaller than 100 Mega Bytes, and does not have an LCD larger than 3 cm2; wherein upon said unitary mobile apparatus receiving at least one digital code wirelessly from said paired computer terminal, and wherein said at least one digital code indicating a request to change to discoverable mode, said unitary mobile apparatus changes to discoverable; wherein upon said unitary mobile apparatus receiving at least one digital code wirelessly from said computer terminal, wherein said at least one digital code indicating a request to activate proximity monitoring, said unitary mobile apparatus monitors proximity to said computer terminal and upon detection of an event selected from the group consisting of: said short wireless connection dropped due to a loss of signal, said short wireless connection has signal strength that is below a predetermined threshold, said unitary mobile apparatus performs actions selected from the group consisting of: issuing an audible alert and issuing a vibration indication; wherein upon said unitary mobile apparatus receiving at least one digital code wirelessly from said computer terminal wherein said at least one digital code indicating a request to send at least one user digital key, said unitary mobile apparatus verifies that the user is not moving using at least one onboard motion detection means, and only if the user is not moving, sends a wireless response to said computer terminal; wherein said unitary mobile apparatus uses a data communication protocol selected from the group consisting of: Serial Port Profile (SPP), iPod Accessory Protocol (iAP) and NFC to send said digital code, wherein said unitary mobile apparatus uses a communication protocol selected from the group consisting of: Hands Free Profile (HFP), Headset Profile (HSP), Human Interface Device Profile (HID), Advanced Audio Distribution Profile (A2DP) to monitor proximity to said computer terminal.

### BRIEF DESCRIPTION OF THE FIGURES

The present inventions may be more clearly understood by referring to the following figures and further details of the inventions that follow.

FIG. 1A is a schematic of an alternative system for authentication.

FIG. 1B is a schematic of an alternative system for authentication with headset.

FIG. 2A is a block diagram of system for authentication.

FIG. 2B is a block diagram of system for authentication with headset.

FIG. 3 is a flowchart illustrating the operation of a system for authentication.

FIG. 4 is a flowchart illustrating changing discoverable mode.

FIG. 5 is a flowchart illustrating monitoring signal strength.

FIG. 6 is a flowchart illustrating using geo-location to set alert mode.

FIG. 7 is a flowchart illustrating using signal loss and RSSI for alerting.

FIG. 8 is a flowchart illustrating using motion-based authorization.

FIG. 9 is a flowchart illustrating automatic login using a system for authentication.

FIG. 10 is a flowchart illustrating updating data on the system for authentication.

FIG. 11 is a flowchart illustrating biometric authentication.

FIG. 12 is a flowchart illustrating biometric authentication with challenge.

Similar reference numerals are used in different figures to denote similar components.

### FURTHER DETAILS OF THE INVENTIONS

The most common model for PC application login generally relies on a set of user name and password that the user enters in a login screen. Once the user name and login are authenticated, the user gains access to the application.

This model has presents a few security problems. For example:

Multiple users can login with the same username/password,

A person can steal a username and password combination without the account owner noticing. The person can login into the system undetected.

For mobile phone applications, the phone generally goes to sleep mode after one minute of user inaction, and later, the user has to login again. For frequent users of mobile applications, this process is inconvenient and wastes them a lot of time.

The current invention utilizes features of short wireless transceivers (such as BLUETOOTH, ANT, WIBREE, NFC, ZIGBEE, etc.) to provide secure automatic access to mobile payment, mobile banking and mobile CRM applications thus increasing usability, convenience and efficiency to users while maintaining higher security standards. This new technology also provides an alarm when the user mobile terminal is away from the device of the invention, thus preventing loss and theft of mobile terminals.

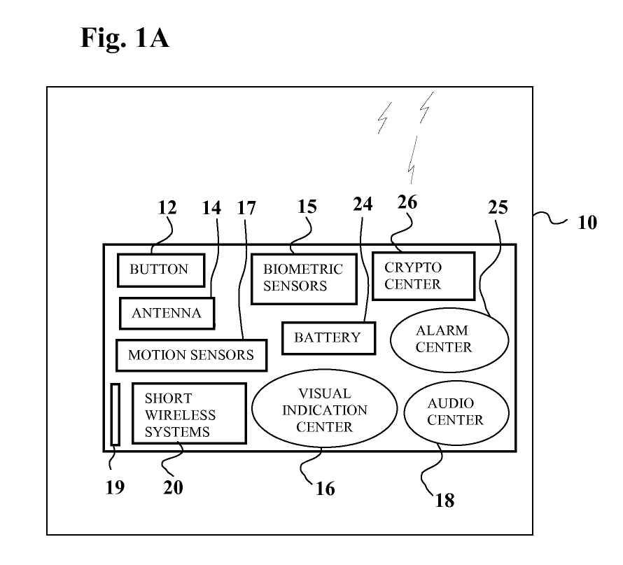

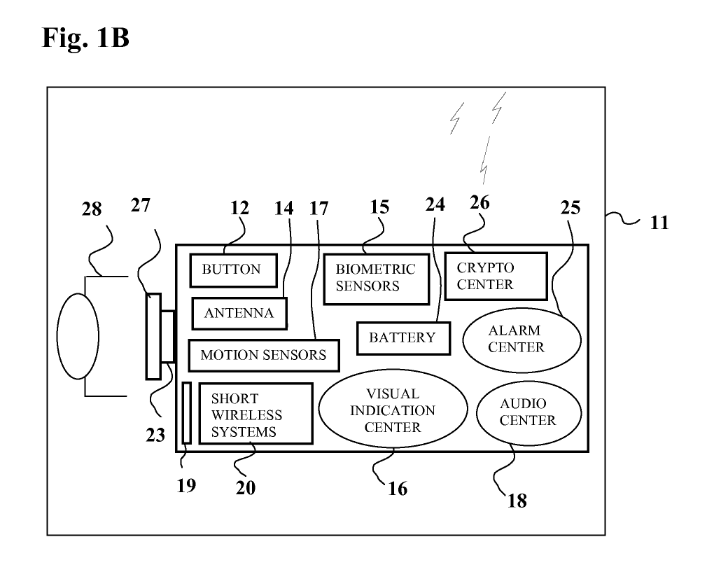

The following provides further details of the present inventions summarized above and illustrated in a schematic fashion in the Figures. In accordance with a first aspect of the present inventions, FIG. 1A is a schematic illustration of a system for authentication 10 comprising short wireless transceivers 20 for short-range communication operatively connected with activation switches 12, an antenna 14, biometric sensors 15, a visual indication center (or display) 16, motion sensors 17, audio center 18, connectors 19, battery (or power supply) 24, and communication/alarm center 25.

Referring to FIG. 1B, an alternative schematic illustration of a system for authentication 11 comprises a short wireless system 20 connected with activation switches 12, antenna 14, biometric sensors 15, visual indication center (or display) 16, motion sensors 17, audio center 18, connectors 19, bearing 23, power store 24, communication center 25, speaker 27 and capsule 28.

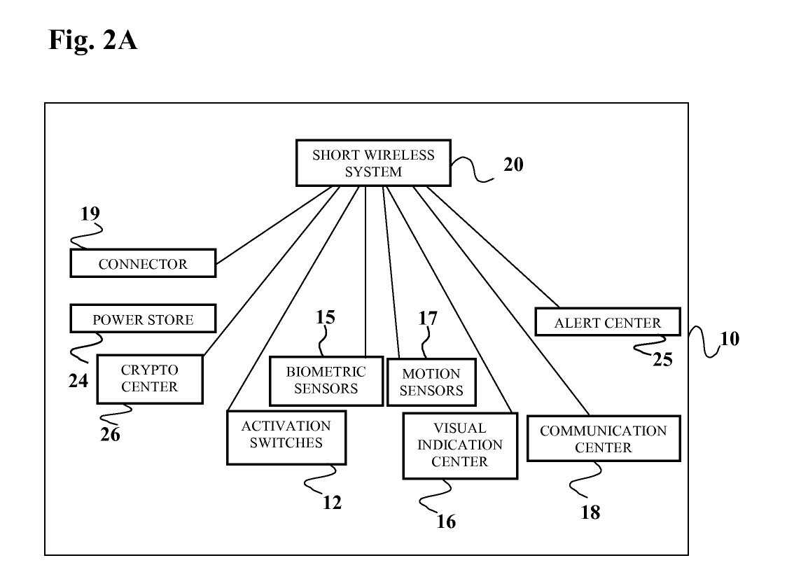

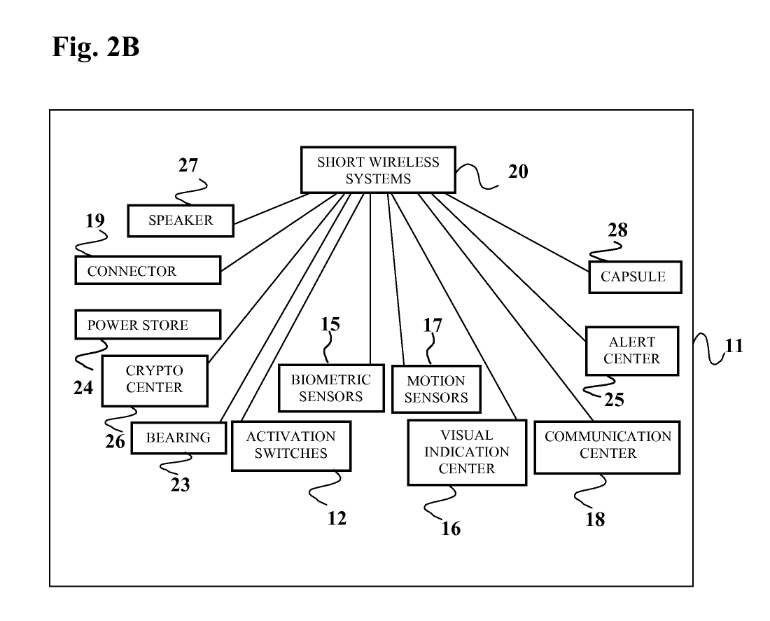

Referring to FIG. 2A, in an embodiment, system for authentication 10 comprises short wireless transceivers 20 for short-range communication operatively connected with activation switches 12, an antenna 14, biometric sensors 15, a visual indication center (or display) 16, motion sensors 17, audio center 18, connectors 19, battery (or power supply) 24, and communication/alarm center 25.

Referring to FIG. 2B, in an embodiment, system for authentication 11 comprises a short wireless system 20 connected with activation switches 12, antenna 14, biometric sensors 15, visual indication center (or display) 16, motion sensors 17, audio center 18, connectors 19, bearing 23, power store 24, communication center 25, speaker 27 and capsule 28.

Short wireless system 20 enables connectivity over short wireless radio bands and includes a radio and base band IC for BLUETOOTH, WIFI, NFC, ANT, ZIGBEE or any combination of the above. In a preferred embodiment, Short wireless system 20 includes ROM, Flash memory or external memory or any other type of memory.

In a preferred embodiment, memory is less than 100 Mega Bytes.
In a preferred embodiment, memory is less than 10 Mega Bytes.
In another preferred embodiment, memory is less than 1 Mega Byte.
In an alternative embodiment, Short wireless system 20 includes a power amplifier (PA) and/or low noise amplifier (LNA) for increasing the transmission range.
Short wireless system 20 comprises a BLUETOOTH/short wireless chipset with on-chip microcontroller (such as the one supplied by CSR), Flash memory and antenna.

Control or activation switches 12 can be any type of button, switch, remote sensor, touch sensor, contact sensor or activation system. Activation switches 12 are used to turn the system for authentication 10/11 ON/OFF, to shut off the alarm, to change the BLUETOOTH/short wireless system mode to pairing mode, and/or to start voice transmission for embodiments that have a microphone and/or speaker. For example, a single control button can cycle through a menu of functions by changing the length of time that the button is held and/or the speed with which a first press is followed by a second press (analogous to the single and double click on a computer mouse).

One or two control buttons coupled with a simple display screen can adjust a variety of operational parameters.
Switch 12 has several modes. In a preferred mode, a long press of activation button or switch 12 on the base unit 10 indicates ON/OFF event. A long press may be defined by either the length of time that Button or switch 12 is manually held in a second position against a bias that holds the switch in a first position when at rest, or a signal may be given to indicate that a desired mode of operation or desired action has been initiated. For example, a very long press can cause a switch to pairing mode.
Button or switch 12 can be used to dial a number, or to perform actions such as accept/reject a call, or play/stop/forward/back.

Antenna 14 can be any type of antenna including chip antenna, patch antenna, PCB antenna and dipole antennas.

Biometric sensors 15 can be any type of biometric sensor.

In a preferred embodiment, biometric sensor 15 is a microphone for capturing a sample user voice. The sample of user voice can be compared to an existing sample of the original user's voice. The original sample is generally recorded during initiation and configuration phase. If correlation factor is above a threshold, the user is authenticated. In another preferred embodiment, biometric sensor 15 is an accelerometer for capturing accelerations corresponding to user movements in three dimensional space. The accelerometers correspond to a first set of one or more symbols or a first signature, or accelerations corresponding to user movements in two dimensional space corresponding to a second set of one or more symbols or a second signature.
The sample of user accelerations can be compared to an existing sample of the original user's accelerations corresponding to a first or second set of symbols or first or second signature. The original sample is generally recorded during initiation and configuration phase. If correlation factor is above a threshold, the user is authenticated.
Biometric sensors 15 can also a scanner for reading finger prints or a camera for capturing iris scan.
In one embodiment, the system for authentication 10/11 stores a user biometric identification signature (or an encrypted user biometric identification signature).
The biometric identification signature can be a sample or a pre-processed sample of the user's signature, voice, finger print, iris scan or distinguishing biometric identification. The identification signature can also include variations that correspond to different user conditions, tones, states, etc.
Biometric sensors 15 can be an accelerometer, and can be used to capture a user's hand signature. Biometric sensors 15 can be a microphone, and can be used to capture a user's voice.
Upon reading new user biometric information, the system for authentication 10 compares the new user biometric information with the stored user biometric identification signature using an onboard processor for calculating correlation factors and comparing them to acceptable thresholds and authenticates the user is who he is (or not).
The user authentication or biometric validation can occur on a periodic basis, or upon receipt of an event or a message.
In another embodiment, the user biometric identification signature can be stored on a server.

Upon receipt of an event or a message to authenticate the user or upon detection of an event—such as wrong PIN code, change of driver, reset, detection of unknown conditions, a predetermined period of time elapses, the system for authentication 10/11 requests the user to provide biometric information.

Upon reading new user biometric information, the system for authentication 10/11 sends the new user biometric information to the server for comparison with the stored user biometric identification signature.

Visual indication center 16 comprises LED, LCD, projector or any type of display. The LED can turn on and off periodically to indicate the system is on. The color and frequency of the LEDs can indicate different events such as normal mode, pairing mode, alarm mode, low battery mode, voice mode, etc.

In another embodiment, visual indication center 16 can be an LED, LCD or any other indication means. It can be used to indicate the status of the device, such as whether it is powered, if the BLUETOOTH/short wireless transceiver system (BT) is discoverable or non-discoverable, if the BT is pairing or paired with another BT, the BT mode, inter alia.

System for authentication 10/11 may include an onboard motion sensor 17 or tilt detector. Motion sensor 17 can be used to detect if the user is in motion or idle, and to authorize or deny response depending on if the user is in motion or idle. This is used to reduce a security hack attack “Relay Attack” that is known in keyless entry systems used by car manufacturers. Most keyless entry systems today respond upon receiving a request. This feature is exploited by hackers in order to hack the system. It has been noted that when a user is asking for access to a door, car, Facebook, . . . the user has to stop moving. For that reason, a motion sensor is used to deny responses when the user is not idle and to respond when the user is idle.

For example, while the user is walking next to his car, System for authentication 10/11 will not respond to any wireless message. If System for authentication 10/11 receives a valid message while the user is not moving, it will respond.
Motion sensors 17 can also be used to reduce false alarms. For example, if System for authentication 10/11 detects a signal loss while it is not moving, the security threat is lower, and the alert can be different from then the system is moving. The case where motion is not detected generally corresponds to the user staying at home, office or coffee shop . . . , and leaving system for authentication 10/11 on a table while the mobile phone leaves proximity. On the other hand, when System for authentication 10/11 is moving and a signal loss occurs, this case often corresponds to the user leaving the mobile device behind, and thus the security risk is much higher.

Audio center 18 can be any type of microphone, speaker, earphone wire, foldable earpiece, slid able earpiece, pull-up earpiece, telescopic earpiece, rotating telescopic earpiece, etc.

Connector 19 can be any type of connector. Connector 19 is used for charging, flashing data, connecting a headset device, connecting a second headset device for stereo sound, or connecting another peripheral.

Bearing 23 can be a pivot, articulation, U joint, a ball joint, pop-up coil, slide rail, a telescoping tube, or any attachment mechanism for a detachable or movable earpiece.

Battery 24 provides power to some of the components of system for authentication 10. Battery 24 can be a fuel cell, nickel-cadmium, lithium, lithium polymer, lithium ion, alkaline or nickel-hydride battery or any other portable source of electric power. Battery 24 can also be replaced with photovoltaic cells, a rechargeable battery, or a battery rechargeable from a distance (such as by induction). When system for authentication 10/11 is not exchanging data or alarming, it remains in a dormant state (“sleep-mode”) to conserve the energy of battery 24. On event selected from: receiving request for data, disconnect event detected, receiving request to establish voice channel, system for authentication 10/11 leaves the sleep mode and wakes up. For example, small 1.5 volt batteries, and the like, such as those used in small devices like hearing aids, calculators and watches are widely available and can be used as for a power source. It is noted that on detection of low battery level, system for authentication 10/11 sends a notification message to the paired device.

Alarm center 25 includes an alarm audible from a distance greater than 6 feet.

In a preferred embodiment, the system for authentication 10/11 does not have an LCD.

In a preferred embodiment, the system for authentication 10/11 does not have an LCD larger than 3 cm2. A regular alarm is between 65 and 120 decibels at 10 feet. Noise levels above 85 decibels can harm hearing over time. Noise levels above 140 decibels can cause damage to hearing after just one exposure. In a preferred embodiment, alarm center 25 has more than 50 decibels or 50 dBA at 10 feet or exceeds ambient sound level by 5 decibels minimum. In a preferred embodiment, the alarm provides an audible signal of at least 60 decibels to notify the user of a designated event, such as user leaving proximity of mobile phone. The human ear does not respond equally to all frequencies: humans are much more sensitive to sounds in the frequency range about 1 kHz to 4 kHz (1000 to 4000 vibrations per second) than to very low or high frequency sounds. Sound meters are usually fitted with a filter that has a frequency response similar to the human ear. If the “A weighting filter” is used, the sound pressure level is given in units of dB(A) or dBA. In residential areas, most noise comes from transportation, construction, industrial, and human and animal sources. Road traffic noise is the leading source of community noise. The noise can be highly variable. It is common that Day-Night sound levels in different areas vary over a range of 50 dB. The outdoor level in a wilderness area may occur as low as 30 to 40 dBA, and as high as 85-90 dBA in an urban area. Most urban dwellers lives in areas of noise level more than 48 dBA.

Alarm center 25 can be any type of audio, video, tactile or mechanical user interface means capable of conveying information to the user. Audio means can be any audio device such as a speaker, a buzzer, a Piezo buzzer, omni-directional speaker, directional speaker, an ultrasound or any other audio device. Visual means can be an LED, or any visual information display device. Tactile means can be any tactile sensor such as a vibrator, or a heat-generating device.
Crypto center 26 includes authentication, hashing, encryption, AES256, SHA256 and Secure Element chipsets. It encrypts information and stores it. We can use symmetric encryption such as Advanced Encryption Standard (AES) (AES-128, AES-192 and AES-256), Triple DES (3DES) or asymmetric encryption such as RSA (Rivest, Shamir and Adleman). In this embodiment, the system for authentication 10/11 and PED use a cryptographic hash function such as SHA-0, SHA-1, SHA-2, MD5 or other hash functions to authenticate each other, prior to the system for authentication 10/11 sending the one or more keys in encrypted form.

Speaker 27 can mount to bearing 23 and may allow adjusting the angle and distance of speaker 27 relative to the main body of system for authentication 10/11 across one or more planes for better comfort.

Capsule 28 can easily attach and detach to system for authentication 10/11. Capsule 28 allows protecting speaker 27 while not in use. Capsule 28 can attach to a key chain and allow easy carrying of system for authentication 10/11 as a key chain when not in use as a headset, and to easily detach it and use it as a headset when needed.

Automatic Login:

A user application running on a mobile device or a PC can be programmed to verify that the system for authentication 10/11 is within proximity, and if so, the user authentication parameters such as password, One Time Password (OTP), Challenge Response, OTP Challenge Response, the user is logged in automatically without entering information in a login screen or on entering a short PIN code.
The login parameters are transferred wirelessly when they are needed by the application and authenticated by either the application, a server or a RADIUS server. If the user does not have the device with him/her, a login screen may be used to enter authentication parameters and gain access to the application.
Example: A user is using an NFC enabled mobile phone to make NFC payment transaction. Traditionally, the user has to entering a password to a mobile phone payment application every time the user is making a payment. The user can use system for authentication 10/11 to provide the password automatically to the mobile phone application (during a period of time that is configurable from the mobile payment application). This feature allows the client to gain more convenience and efficiency. System for authentication 10/11 may store multiple login parameters/digital keys corresponding to multiple client applications, and when client application requests login parameters, system for authentication 10/11 automatically determines login parameters corresponding to the client application and sends those parameters wirelessly.
In another alternative embodiment, the system for authentication 10/11 stores user parameters and runs as a BLUETOOTH HID profile device (keyboard profile). When the user pushes a button, the user access code is generates, and typed to the application onboard the mobile, PC or web.

Authentication:

Authenticating a response may involve local authentication, whereby the received data is authenticated.
Authenticating a response may involve communicating with a server, sending data such as user name and password to the server, and waiting for server authentication.
Authenticating a response may involve sending data to a RADIUS server (Remote Authentication Dial In User Service) that provides centralized access and authorization. In another embodiment, the application sends a seed and a synchronization time to system for authentication 10/11. System for authentication 10/11 uses a pseudo-random number generator to generate a password, and sends it back to the application. The application sends the password to a server that compares the password to a pseudo-random number generator at the server. If the foregoing matches, the server grants access to the client.
It is noted that once the two-way wireless communication channel is established, the application communicates with system for authentication 10/11 in real-time. If authentication is successful, the application automatically provides access to the user. In an alternative embodiment, if connection is not established, response is not received, or response is not authenticated, the application displays a login screen.
In an alternative embodiment, the user may enter configuration parameters for system for authentication 10/11 through an application. Configuration parameters may include but are not limited to user name, password, private key, authentication parameter, personal info, biometric info, operation hours, operation days, buzzer type, buzzer volume, buzzer duration, alarm type, and user preferences such as seat position, steering wheel inclination, rear view mirror position, side mirror position, radio station, security code and access code. The configuration parameters are flashed onboard the system for authentication 10/11.

In another preferred embodiment, system for authentication 10/11 comprises a keypad for entering user data. Alternatively, it may comprise a finger print scanner, a voice synthesizer or an iris scanner for authenticating user. System for authentication 10/11 may comprise an LCD.

App Store:

In a preferred embodiment, an App Store is used to enable an employee to select interfaces for which the user requests access. The App Store enables a supervisor to approve the employee requests. It will then prepare update files for download to a computer. The update files may contain a Device Firmware Upgrade (DFU) programmer; alternatively, a DFU programmer may be accessed from the computer. The DFU programmer is used to flash a device update file from the downloaded updates files to the system for authentication 10/11. The system for authentication 10/11 contains a loader program with a public key. The loader program authenticates the device update file. If it finds that the private key in the device update file matches the public key, it will enable flashing of the system for authentication 10/11.
The downloaded update files may contain a program that will run on the employee's computer or device, or a configuration file that will be used to configure an interface onboard the employee's computer of device. This will enable the employee's computer of device to be able to pair with the system for authentication 10/11 and to obtain digital keys.
Alternatively, the downloaded files contain an API that will be used for programming interfacing functionality into a third party application.
The downloaded update files may contain a configuration file that can be used to program a lock or a server.
In a preferred embodiment, the App Store is hosted in the cloud, for example on Force.com or other cloud infrastructure.

User Keys

A user digital key can be a private key, public key, part of a private key, part of a public key, an encoded/encrypted/obfuscated private key/public key, part of a private key, part of a public key, a One Time Password (OTP), a response to challenges-response question, a response to OTP challenge-response. The access interface may send an obfuscation/encrypted formula so that system for authentication 10/11 can obfuscate/encrypt transmitted information, can return it within a predetermined period (for example a second) and so that the lock system may de-obfuscate/de-crypt the returned result.

In a preferred embodiment, system for authentication 10/11 stores a part of a private key. It receives a message from PED containing an obfuscation formula, for example, a large random number and a code for an obfuscation formula.

An update program can set the system for authentication to discoverable, and can set conditions for pairing or pairing rules. The system for authentication preserves its pairings to old devices for which it was previously paired, and on top of that, it will have pairings to additional new devices.
For example, it can define:
a—pairing is authorized to n devices (n can be 1, 2, . . . ),
b—pairing is authorized to n devices (n can be 1, 2, . . . ) with a restricted BLUETOOTH ID between x and y,
c—pairing is authorized to n devices with a class of service xxx,
d—pairing is authorized to n devices with device name yyy,
e—pairing is authorized during a maximum period of time (o),
f—maximum number of unsuccessful pairing attempts is m (m can be 1, 2, . . . )
   Once the pairing conditions are met, the system for authentication becomes non discoverable.
   The system for authentication can be programmed with operation rules such us: turn LED on and off, checking a private key matches a public key, encrypting, obfuscating, returning XML string, storing function codes, responding to messages, encrypting and decrypting voice, scan for other compatible devices, send marketing files, store counters, provide any function.
   The update program can also program the system for authentication to:
store keys, store different keys for different interfaces,
store different protocols and authentication methods corresponding to different interfaces,
when a request is received, provide one or more keys,
when a request is received from an interface n, provide data corresponding to interface n,
store one or more encryption or obfuscation functions identified by one or more function codes,
on receipt of a message identifying function code x and a number of operands, the number of operands can be random, execute encryption function x
function a certain way, lit LEDs, send a marketing file,
   In a preferred embodiment, every time PED sends a message, it identifies a different function for encoding/encryption.
   For example, the system for authentication stores the following table of functions:

| Function Code | Function definition |
|---|---|
| F1 | shift code by third operand |
| YX | convert code to hex, add to fourth operand |
| 7C | convert code to hex, multiply by second |
| | operand |

The system for authentication stores the code 1111

If message received is: F1 5 0 1 0 then the returned message is 01111 (shift 1111 by 1=>01111)

If message received is: YX 1 2 3 4 5 6 then the returned message is 31313135 (convert 1111 to hex=>31313131=>add 4=>31313135)

If message received is: 7C 2 1 2 1 then the returned message is 31313131 (convert 1111 to hex=>31313131=>multiply by 1=>31313131)

Upon receive of a reply from the system for authentication within predetermined period of time, the application or device or server applies a reverse function corresponding to the sent function code. Example:
If the message sent is: F1 5 0 1 0 then the message received is 01111, and by applying a reverse function to F1, the code 1111 is obtained.
If the message sent is YX 1 2 3 4 5 6 then the message received is 31313135, and by applying a reverse function to YX, the code 1111 is obtained.
If the message sent is 7C 2 1 2 1 then the message received is 31313131, and by applying a reverse function to 7C, the code 1111 is obtained.

Biometric:

Further, for more security, the user may provide biographic authentication such as be not limited to voice recognition, password entry, retinal scan, finger print, finger vein scanner or other information, thus system for authentication 10/11 only function if user is validated.

Lost Device:

If the user lost the system for authentication, the user device pairing to the system for authentication will be un-paired using an application or by pressing a reset button. This way, the system for authentication will no longer be a security threat, and cannot be used for any access.

Data Synchronization

The system for authentication 10/11 can be connect to a computer using port 19 and user data can be flashed to system 10/11 or written to memory (RAM or flash) onboard system 10/11. User data can be password, private keys, public keys, authentication parameter, personal info, biometric info, OTP seed, configuration parameters, operation hours, operation days, buzzer type, buzzer volume, buzzer duration, and alarm type.
Those parameters can be flashed on system for authentication 10/11 by connecting it to another programming device (e.g. programmer, vehicle computer). Those parameters can also be transferred wirelessly and stored.
A user can purchase/acquire/install a lock system that comes with a digital access code (provided on a CD, memory card, USB flash, email, or any way for transferring digital data). The user can later update system for authentication 10/11 with the new digital access code by connecting system for authentication 10/11 to a PED, and transferring the new digital access code to system for authentication 10/11. The new digital code will be stored onboard system for authentication 10/11. The new digital code may be transferred to system for authentication 10/11 through SPI flashing or DFU (Device Firmware Upgrade) or any other method of writing data to device.
In another embodiment, the user may use the system for authentication 10/11 with a first device in a first space, and then connect to a second device in a second space. The first device in a first space may provide the system for authentication with information such as last used radio station, last played record, last seat position, last rear-view mirror position, last light settings, last user adjustments, last visited web sites, last viewed channel, last environment variables, last user settings and preferences. The information is written to the memory wirelessly without connecting a cable. The information may be written to flash memory. When the user connects to the second device, the second device may request the last environment variables or the last user settings and preferences. It may use them to set the settings and preferences on the second device to the same values as those on the first device.
For example, a user is inside the home, and is listening to radio station A. When the user goes to his/her car, the car radio will set to radio station A.

No Reset:

The system for authentication is designed so that it does not allow reset, and it does not go to discoverable mode unless it is updated through an authorized update application The system for authentication 10/11 pairs with a second apparatus. Once paired to a predefined number of devices, it becomes undiscoverable or invisible to any other device except second apparatus and will not respond to any request from any device except second apparatus. It can establish secure two-way wireless connection with a second apparatus.
In another preferred embodiment, if number of unsuccessful pairing attempts exceeds a predefined number, the system for authentication 10/11 changes to undiscoverable.
In another preferred embodiment, if period of time passed exceeds a predefined period, the system for authentication 10/11 changes to undiscoverable.
In a preferred embodiment, the system for authentication 10/11 does not have a reset button, cannot be reset and cannot change to discoverable mode unless through a specific programmer system or using a firmware that has appropriate signatures to be loaded onto the system for authentication 10/11 and to instruct it to reset or to change to pairing mode or to change to discoverable.
In a preferred embodiment, the system for authentication 10/11 appears as a BLUETOOTH headset to other BLUETOOTH/short wireless mobile devices. After the user initiates a pairing request, the system for authentication 10/11 obtains the BLUETOOTH/short wireless address of the device to be monitored and stores it in memory. Short wireless system 20 changes to undiscoverable mode and visual information center 16 changes to normal mode.

Proximity Alert:

After the user is logged in to an application onboard a mobile device, PC, Web, if a low-signal indication is received from system for authentication 10/11 or is signal loss is detected, the user application onboard the mobile device or PC may issue warnings to the user, may close any open document, may encrypt any decrypted file, may disconnect, and may issue visual, audible and motion alerts.
If the user is not logged in to an application onboard a mobile device or tablet, system for authentication 10/11 may connect to the mobile device or tablet as a headset profile or handsfree profile. That way, on detection of a loss of link, an alert is issued to the user.
After the user is logged in to an application onboard a mobile device or tablet, if the user tries to access the application after being idle for a period of time, if a disconnect occurred during this period of time, the user is required to enter a PIN code. If the idle period has exceeded a threshold, the user is asked to enter PIN code.
On connection drop, the system for authentication 10/11 may attempt to reconnect and can issue an intelligent alarm, issue a visual or vibration indication. Furthermore, the application or device may logout the user, may lock, block access, shut down, encrypt data, logout, request biometric authentication, issue alarm, report the event to a remote server, send an alert message, or issue an alarm.
For a mobile phone proximity detector, a connection drop is generally due to the distance between short wireless system 20 and the mobile phone being too large, an obstacle between the two devices, and/or the mobile phone powered down.
Automatic reconnection minimizes false alarms and makes the systems of the present invention more reliable and easy to use. An exemplary benefit of the automatic reconnect feature is that when a user comes into proximity of the mobile phone from out of range, the alarm automatically shuts off without requiring any additional input from the user.
In a preferred embodiment of the present inventions, the system for authentication will generate an indication or message on detection of a connection drop. The firmware detects a disconnect indication and instructs one or more responses to a disconnect indication. For example, the program will instruct a reconnection attempt and/or instruct issuance of an alert.
It has been discovered by the present inventor that the disconnect event indicator is reliable for detecting that a monitored device is outside a desired range. The claimed invention has an automatic reconnect attempt feature, so that upon detection of a disconnect event, reconnection is attempted; this can avoid many false alarms.
Preferably, in an embodiment, an alarm instruction is not given until at least one active reconnect attempt is made and fails. Upon the alarm issuing, periodic reconnect efforts are made, and upon reconnection the alarm will not continue. Avoidance of false alarms makes the invention more convenient for the user.
Furthermore, on detection of signal strength (RSSI) below a threshold, the short wireless system can send a message to the host terminal indicating low signal strength or return to normal mode. This information can be used to allow/deny access, close applications, lock screen, encrypt files, issue warnings, etc.
Upon said computer terminal sending at least one digital code wirelessly to said paired unitary mobile apparatus, wherein said at least one digital code indicating to deactivate proximity monitoring, said unitary mobile apparatus stops indicating events corresponding to loss of proximity.
Upon the computer terminal receiving a digital code from the unitary mobile apparatus, wherein said the digital code indicates an alert condition, the computer terminal performs actions selected from the group consisting of: issuing an audible alert, issuing a vibration indication, closing a document, closing a connection to a server.
Upon the computer terminal detecting an event selected from the group consisting of:
said short wireless connection dropped due to a loss of signal,
said short wireless connection has signal strength below a predetermined threshold,
said computer terminal performs actions selected from the group consisting of:
issuing an audible alert, issuing a vibration indication, closing a document, closing a connection to a server.

Earpiece:

System for authentication 10/11 may have a foldable or slide able earpiece 27. The earpiece 27 can be used as a BLUETOOTH headset. Also, voice from earpiece 27 can be encrypted and voice from microphone encrypted onboard System for authentication 10/11.
In another embodiment, earpiece 27 connects to System for authentication 10/11 through connector 19.

Keyless Go:

Cars nowadays offer voice solutions when the user is inside the car, and it would be more interesting for car manufacturers to provide a total solution, regardless of where the user is. Thus system for authentication 10/11 can complement voice service through the car key when the user is outside the car. System for authentication 10/11 is flat when it is not inserted in the ear, and can have the shape of a headset when folded. System for authentication 10/11 can include a metal key to be used in case onboard battery is out of charge. It can also include a second transceiver, an NFC antenna, an MP3/MP4 player, a recorder, a bio sensor, a comb, a flash light, a lighter, a Swiss knife, an induction charger, an NFC transceiver.
In another preferred embodiment, system for authentication 10/11 can also be used as an automobile key. System for authentication 10/11 can store user preferences such as: seat position, steering wheel inclination, rear view mirror position, side mirror position, radio station, security code, access code.
When the user pulls a door handle, the automobile electronic system requests authentication parameters from system for authentication 10/11 and if authenticated, automatically unlocks the door. When a connection drop is detected, the door is automatically locked.
When the user presses the engine button, the automobile electronic system authenticates system for authentication 10/11 and starts the engine.
The automobile electronic system can request user parameters from system for authentication 10/11 can use the user information to adjust seat position, adjust wheel position, adjust side mirror position, adjust rear view mirror position or adjust radio station.

Parked Vehicle Locator:

In an alternative embodiment, a GPS system onboard a vehicle sends GPS information to system for authentication 10/11. GPS information is sent on detection of vehicle going into parking position. Alternatively, said GPS information is sent regularly. System for authentication 10/11 over-writes old positions with new GPS position. System for authentication 10/11 stores the GPS information representing the last known position of the vehicle. When the user walks away from the parked vehicle, system for authentication 10/11 will have the last known GPS position of the vehicle stored on it. When the user wishes to receive instructions on returning to his/her parked vehicle, said user activates an application onboard his/her PED. PED sends a request for information to system for authentication 10/11. System for authentication 10/11 sends GPS information representing the last known vehicle position. System for authentication 10/11 also obtains heading information from an onboard electronic compass and sends heading information.
PED obtains a response from system for authentication 10/11 containing GPS and heading information. PED uses an onboard GPS receiver to obtain new user GPS position information.
It is common knowledge that given 2 GPS positions, the distance between them can be calculated. Also, it is known that given 2 positions (origin and destination), the angle between True North and destination from origin can be calculated.
Therefore, given current heading relative to True North, a vector pointing to destination can be drawn.
PED displays distance from origin to destination. Furthermore, PED displays an arrow pointing toward destination to user. This information helps the user to return to his/her parked vehicle.

API:

In another preferred embodiment, system for authentication 10/11 comes with an API (application programming interface) that allows developers to integrate wireless authentication in their applications based on BLUETOOTH or short wireless proximity. Wireless authentication enables automatic login function or single log-on function based on short wireless proximity. The login may involve verifying the user credentials against a local database or sending them to a Remote Authentication Dial In User Service (RADIUS) server. The developer application can be any PC, server or mobile terminal application including web applications that run in a browser. When system for authentication 10/11 is within proximity, the user is logged in automatically. When system for authentication 10/11 is out of proximity, the user is not logged in automatically. This provides a secure platform for enterprise applications where access is granted to people that carry system for authentication 10/11, however, unauthorized users that do not carry system for authentication 10/11 are not granted access. This feature also prevents identity theft and unauthorized access. Furthermore, since mobile phones and mobile terminal can be lost stolen and forgotten, this system prevents loss and theft, and at the same time prevents access by unauthorized users.
In another preferred embodiment, the web application API makes a call to a browser plug-in. The plug-in enables the browser to automatically install short wireless drivers if they are not previously installed (user authorization may be required). Furthermore, the plug-in enables the browser application to communicate with system for authentication 10/11 and to send and receive data to/from it. For example, the application may request user name and/or password from system for authentication 10/11. The application may also request digital keys or any other information.
In another preferred embodiment, system for authentication 10/11 comprises authentication means such as finger print reader, voice synthesizer, iris scanner.

Charging

In another embodiment, system for authentication 10/11 can charge its battery from a vehicle's ignition system, whereby when system for authentication 10/11 is placed in the ignition system, it recharges. In a preferred embodiment, the system for authentication has an induction charger.

All in One

A Since most people carry a wallet, a mobile phone and keys, system for authentication 10/11 provides a user with valuable all in one features and at the same time does not require the user to carry an extra device. The features include:

Proximity alarm for mobile phone-Headset for mobile phone-Locator for parked vehicle-Vehicle keys-Door keys-NFC

Small Size:

A significant benefit of this system is the ability to monitor a connection while keeping power consumption to a very low level. This enables one of ordinary skill in the art to build portable devices in accordance with the present inventions that use small batteries (100-200 mAh), which can last for at least 2 or 3 weeks before being recharged or swapped.
System for authentication 10/11 may have a sleep mode and when in sleep mode, battery consumption is below 1 mA. System for authentication 10/11 consumption is generally below 40 mA. Its size is below 10 cubic centimeters, and it weighs less than 25 grams.
In a preferred embodiment, system for authentication 10/11 has a size equal to or smaller than 5 cm×3 cm×1.5 cm or 22.5 cubic centimeters (“cc”) and is less than 50 g in weight.
In an embodiment, there are no manually operated controls (e.g., off-on or activation button is magnetically operated, so the housing is not provided with button or switch access), and the device may not have a display.
System for authentication 10/11 may have a detachable capsule 28 that has a keychain ring.
An attachment mechanism or system, including but not limited to a hook, harness, notebook security lock, insert, pin, clip, badge, clip, key chain, ring, tee, dog collar, Velcro, ring, fastening mechanism, sticky surface are optionally attached to the system for authentication 10/11.
In an embodiment, system for authentication 10/11 can be inserted beneath the skin of a human or animal or included inside the housing of objects such as portable computers. System for authentication 10/11 can also be encased in waterproof packaging and attached to clothes.
System for authentication 10/11 may have a lighted area where a logo can be placed. For example, the status LED can be used to periodically light a logo thus increasing the value of the system.

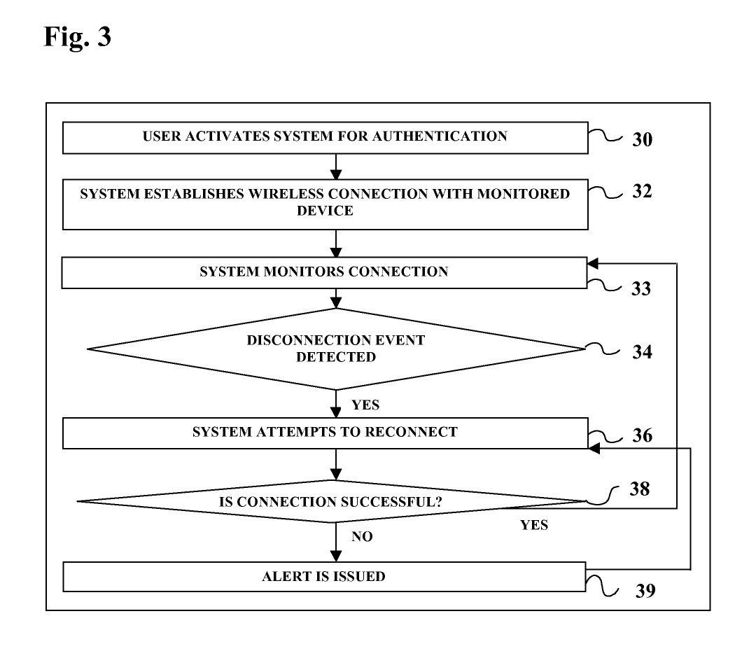

Turning now to FIG. 3, the flowchart illustrates the steps involved in detecting that a portable electronic device (PED) is outside a desired range of a base device (a base device may be referred to as a master and the monitored remote devices referred to as slaves). The PED can be for example a mobile phone, a PDA, a wireless email device, an instant messaging device, a pager, a portable computer, an MP3 player, a portable music player, a portable radio, or any PED. In step 30, the user activates system for authentication 10/11 by pressing activation switch or button or switch 12. In step 32, short wireless system 20 in a base unit establishes a short wireless connection with a monitored remote device. The wireless connection can be an HSP (headset profile) connection, a HFP (Hands-Free profile) connection, a HID (Human Interface Device), iAP (iPhone SPP-like protocol). Other connection profiles may be possible.

In a preferred embodiment, an SPP or iAP connection is used to send data/commands. The SPP/iAP connection requires an application to run on the mobile. A second HFP/HSP/HID connection is used to monitor proximity. HFP/HSP/HID do not require an application to run on the mobile terminal. The two connections can be maintained simultaneously when the application is running, and proximity monitoring is ON. Also, when the user stops using an application onboard a mobile terminal, the SPP connection is closed, and the HFP/HSP/HID . . . connection can be maintained. This enables to monitor proximity of the mobile phone 24/24.
Short wireless system 20 may be used to accept/send voice calls. In this case, a microphone and speaker attached to system 20 are used to send/receive voice sound. Short wireless system 20 may also refuse voice calls, so that the mobile phone can process them. Short wireless system 20 uses a BLUETOOTH operational mode that uses minimal power, e.g., one of sniff, hold, or park modes.
In a preferred embodiment, only BLUETOOTH sniff mode is used after pairing to assure low power usage and optimize convenience to the user by reducing the frequency of battery recharging or replacement.
In step 33, short wireless system 20 monitors the short wireless connection automatically. In this step, BLUETOOTH short wireless system 20 is in sniff mode, and power consumption is below 1 mA.
In step 34, on detection of connection drop, i.e., disconnection, short wireless system 20 attempts to reconnect in step 36. For example, when a connection is dropped while the system is in sleep mode or sniff mode, a BLUETOOTH system can automatically generate an event indicating connection drop. In the base and/or remote devices of the present invention, upon the BLUETOOTH system indicating a connection drop either the base and/or the remote will attempt to reconnect to one another or an alarm will be triggered in the base and/or the remote, as illustrated by issuance of an alarm in step 39.

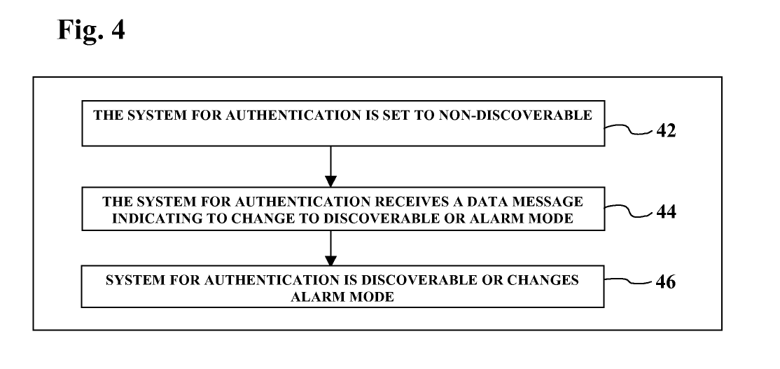

Turning now to FIG. 4, the flowchart illustrates the steps involved in initializing the system for authentication 10/11.

In step 42, the system for authentication 10/11 is set to pairing mode using a programmer or an event. The user pushes Button or switch 12 to activate the system, and the system for authentication 10/11 tries to “pair” with a new device to be monitored (i.e., the user makes a “long press”).
In step 44, on receipt of a message, the system for authentication 10/11 enters pairing mode pr changes alarm mode. The message is generally an SPP or iAP message indicating to switch to discoverable mode (or non discoverable) or alert mode ON/OFF. Visual indication center 16 can indicate pairing mode using a combination of LED effects, for example, alternating colored LEDs. When short wireless system 20 is set to discoverable mode, in accordance with step 46 the user uses a second mobile device to be monitored to search for BLUETOOTH/short wireless devices in range and to select the system for authentication 10/11 from the search list. When a message received indicates alert mode ON, system for authentication 10/11 monitors the monitored device and issues alerts on detection of loss. If alert mode is OFF, system for authentication 10/11 stops monitoring. If new RSSI threshold is received, system for authentication 10/11 uses it to monitor RSSI levels.

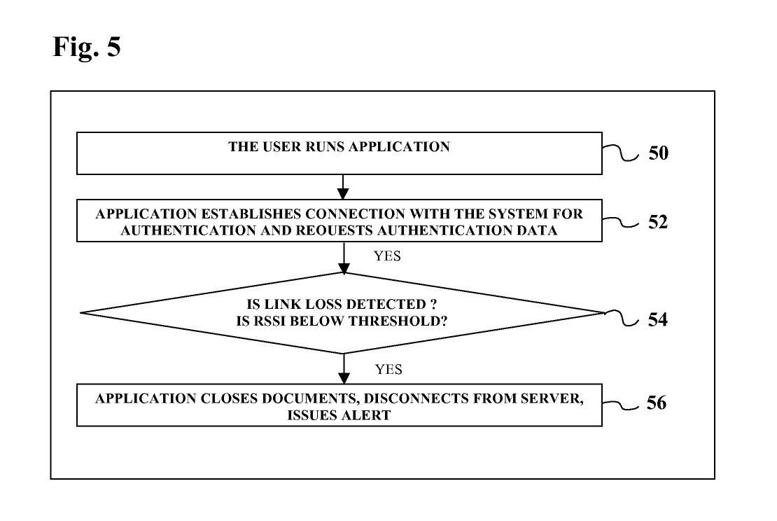

Turning now to FIG. 5, the flowchart illustrates an alternative embodiment using an application. The application can be a corporate application, a web application, a CRM (customer relationship management) application, mobile banking application, NFC (near field communication) application, payment application or other. The application can run on a mobile device such as a mobile phone or PDA, or a PC.

In step 50, the user launches an application. In step 52, the application tries to establish connection with system for authentication 10/11. If connection is established, the application sends a request for data to system for authentication 10/11.
In step 54. if a disconnect or link loss is detected, or if RSSI signal level is below a threshold, or a message received from system for authentication 10/11 indicates low signal RSSI below a threshold, the application closes documents, disconnects from a server and can issue an alert to the user in step 56.

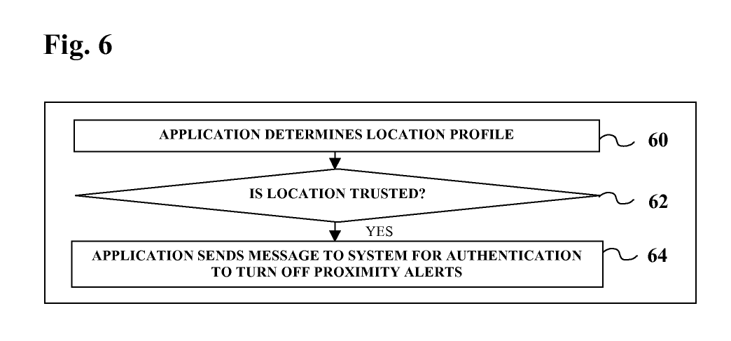

Turning to FIG. 6, the application uses geo-fencing to determine if proximity alerting should be turned ON or OFF or to change RSSI signal threshold depending to location. It can send a message to system for authentication 10/11 to indicate turning alerting function ON or OFF or setting RSSI threshold as in step 44 of FIG. 4.

For example, the application can determine that the user is at a trusted location such as a home or an office, and send a message to system for authentication 10/11 to turn alert function OFF. When the user leaves know locations, it sends a message to system for authentication 10/11 to turn alert function ON. This enables to remove false alerts at trusted locations.
In step 60, the application onboard the mobile terminal determines the current location profile. The application can be a BYOD (Bring Your Own Device) application, or any application. The application determines the current location profile through a simple GPS lookup, or through checking a geo-fencing interface.
The computer terminal detects movement using at least one means onboard the computer terminal selected from the group consisting of: motion detection means, accelerometer, gyroscope, GPS determination means, AGPS determination means, GLONASS determination means. Upon detection of movement, the computer terminal checks the current location to determine if it is trusted or not.
In step 62, if the location is a trusted location, the application sends a message to system for authentication 10/11 to indicate to turn off alerting, turn off proximity monitoring, or increase the range for proximity monitoring.
Alternatively, when the user exits a trusted location, the application will send a message to turn on alerting, turn on proximity monitoring, or decrease range for proximity monitoring.

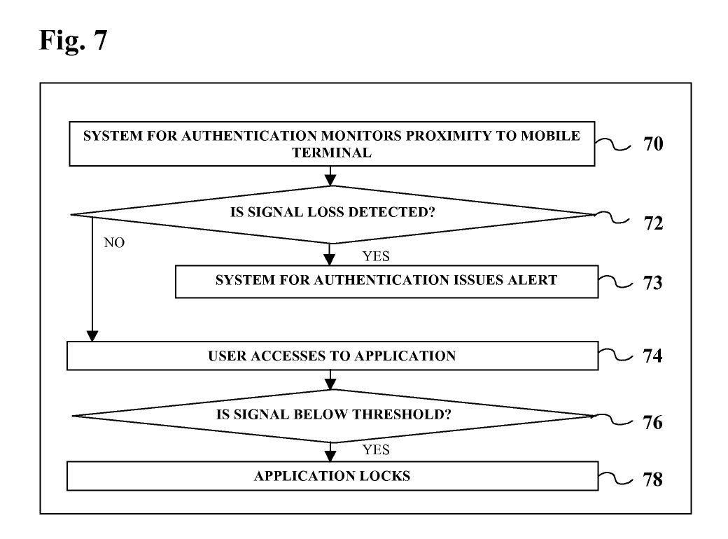

Turning to FIG. 7, the flowchart illustrates the operation of system for authentication. In step 70, system for authentication 10/11 monitors proximity of a mobile terminal, generally through BLUETOOTH handsfree protocol HFP. In step 72, if signal loss is detected, system for authentication 10/11 issues an alert in step 73. In step 74, the user requests access to an application onboard the mobile terminal, and is authenticated, generally through BLUETOOTH SPP protocol or iAP. system for authentication 10/11 monitors the signal strength RSSI on the connection, and in step 76, if the signal strength is below a threshold, the application locks in step 78. The connection may be closed, the application may quit, the documents may lock or close . . . . HFP monitoring enables to monitor the mobile terminal all the time, 24/24. The alert is triggered on link loss, and the range is chosen in a way so that false alerts are minimized. RSSI monitoring enables monitoring while the user is using an application, and allows to choose a shorter range for the time the user is using the application.

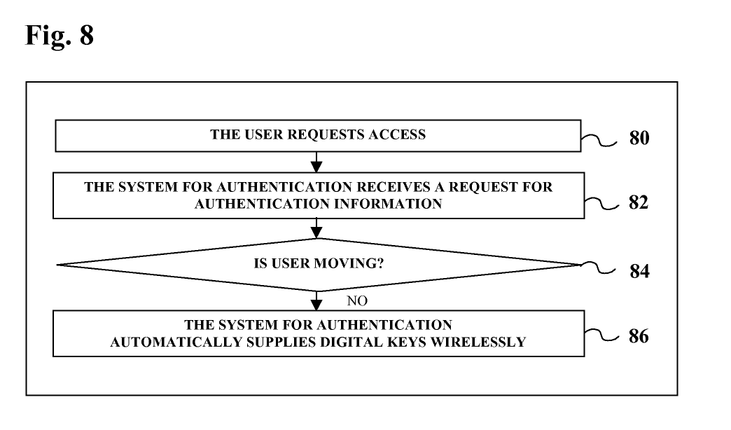

Turning to FIG. 8, the flowchart illustrates the operation of system for authentication. In step 80, a user tries to access an interface. The interface can be an electronic lock that activates a mechanical lock, an electro-mechanical lock, a door lock, a vehicle lock, an actuator, a software interface that activates a lock screen or a password screen, a software interface that encrypts data, a software interface that blocks user from accessing a personal electronic device, any other locking system. For example, user activates handle of locked door, a user clicks on a locked/encrypted file . . . .

The access interface can have an infrared detector, a touch sensor, an NFC detector, an RFID token or any sensor that detects that user is requesting access.
In another preferred embodiment, the access interface detects the presence of a user by sensing physical contact, by sending motion, or by sensing movement. The access interface searches for system for authentication in step 82.
The access interface establishes a secure tow-way wireless connection with system for authentication 10/11 and requests a digital key.
In step 84, motion sensor 17 detect motion.
It has been discovered by the present inventor that motion pattern is reliable for prevention relay attack, and that to do so, an authentication system must refuse connection or request for data is motion pattern is not one for a user who is stopping to gain access.
For example, if the motion pattern indicates that the user is departing, acceleration or not stopping, it means that the user is not trying to gain access. If the motion pattern indicates that the user is stopped or stopping or performing a specific pattern, requests for keys are answered.
This invention solves the current problem with KeylessGo cars from major car manufacturers which are vulnerable to relay attack.
In step 86, System for authentication 10/11 automatically returns digital key wirelessly. On validation of the digital key, and on validation of other factors (such as biometrics, or button push, or touch, or PIN code) the access interface unlocks.
The access interface may try to maintain a wireless connection with system for authentication 10/11, and on detection of a connection drop, lock.
In another embodiment, on detection of connection drop, the lock or device or lock application may request a user code from the user, may block access, logout, encrypt data, lock a device or lock a lock.

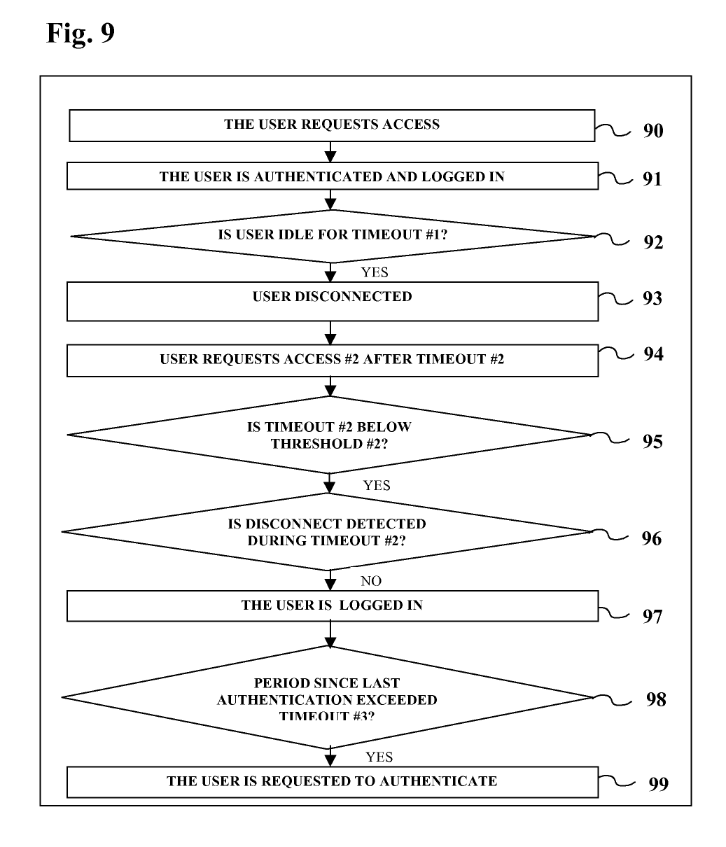

Turning to FIG. 9, the flowchart illustrates the operation of system for authentication. In step 90, the user requests access from access interface. In step 91, the user is authenticated and logged in.

In step 92, when the access interface detects that the user has been idle for a first period of time (Timeout #1) that exceeded a first threshold (Threshold #1), it disconnects the user in step 93.
In step 94, if the user wishes to connect after a second period of time (Timeout #2) that does not exceed a second threshold (Threshold #2), the system checks if a risk situation occurred during Timeout #2 such as signal drop or low RSSI . . . in step 95.
In step 96, if no risk situation occurred, the user is automatically reconnected or logged in (without entering authentication information) in step 97.
In step 98, if the time since last authentication exceeds Timeout #3, the user is requested to enter authentication parameters in step 99.
For example, a system may have a timeout between PIN codes of 2 hours.
During those two hours, and after the user enters a first PIN, the user can log to the system any time (or a predetermined number of time) without being asked for PIN as long as the connection between the user device and the system for authentication has not dropped.
After a connection drop is detected, the user must enter credentials again. This can be a simple PIN code, password, or a more complex questionnaire or interview.
In another embodiment, if the entered information fails authentication a predetermined number of times, the user has to go through an authentication workflow whereby the user may be asked to respond to challenge questions or to contact a support service. The user interface may block access and the user may have to go through a questionnaire or interview to be authenticated.

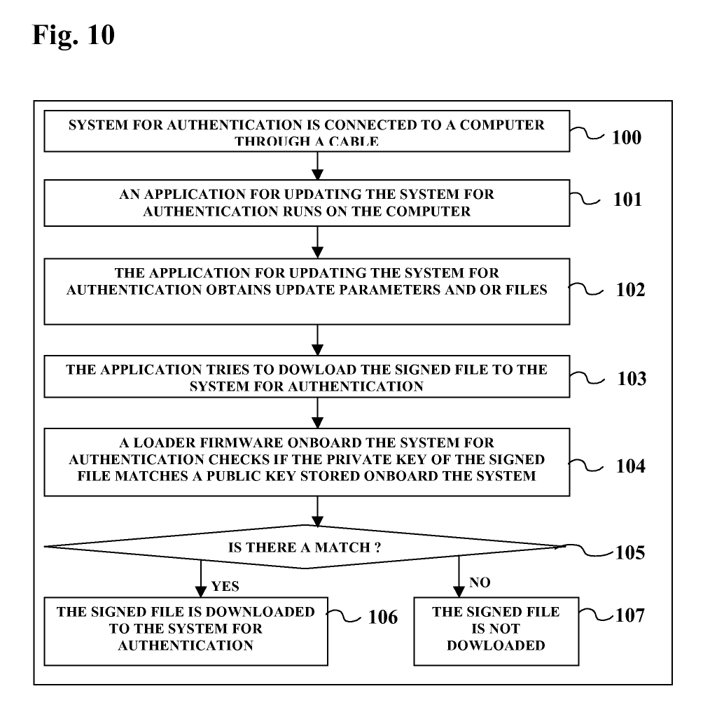

Turning to FIG. 10, the flowchart illustrates updating the system for authentication.

In step 100, the system for authentication is connected to a computer through a cable.
This can be a USB, RS232 or any other cable means.
In step 101, the user runs an application to update the system for authentication. The application can be a program running on the computer, a web service, a web plug-in, or any software running on a specialized device.
In step 102, the application collects update parameters, stack and application, and prepares update files. In a preferred embodiment, the application builds a DFU (device firmware upgrade) file. The application can sign the update files using a private key matching a public key stored on the system for authentication.
In step 103, the application tries to download the signed file to the system for authentication.
In step 104, a resident loader firmware onboard the system for authentication checks if the private key of the signed file matches a public key stored onboard the system or device.
In step 105, if there is a match, the signed file is downloaded to the system for authentication in step 106. When the new firmware executes, it may set the system for authentication to discoverable to enable pairing with a new second device.
In step 107, the signed file is not downloaded.
It is noted that the loader firmware cannot be updated through the data port or through the cable. It can only be updated through access to PCB pins or PCB test points, such as SPI pins. This is so that the firmware onboard the system for authentication cannot be tempered.

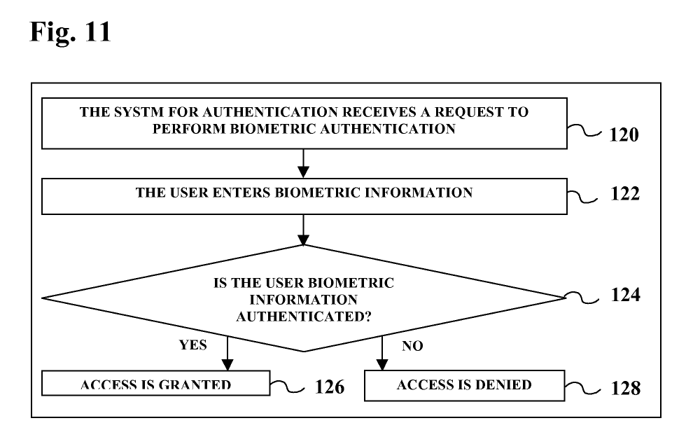

FIG. 11 is a flowchart illustrating three factor authentication. In step 120, the system for authentication 10/11 receives a request to perform biometric authentication.

In one embodiment, the request occurs following a user request for access to device or interface.
In another embodiment, the request occurs following a timeout.
In another embodiment, the request occurs on detection of a wrong PIN code or a number of wrong PIN codes.
In another embodiment, the request occurs on detection of a wrong PIN code or a wrong driver installed on the computer.
In another embodiment, the system for authentication 10/11 performs biometric authentication without receiving a request from an interface or device, for example, on expiration of a timeout, connection drop, detection of tempering, number of incorrect PIN codes exceeds a threshold, number of incorrect authentications exceeded a threshold, number of transactions exceeded a threshold, time period exceeded a threshold.
In another embodiment, the system for authentication 10/11 issues a request to the user to enter biometric information. The request may be an audible request through audio center 18, a visual request through visual indication center 16 or a motion request through a vibrator, or a combination of these elements.
In step 122, the system for authentication 10/11 captures the user biometric data.
In one embodiment, an onboard microphone captures a sample of biometric information corresponding to the user voice.
In another embodiment, an onboard accelerometer captures a sample of biometric information corresponding to user movements in two-dimensional space or user signature, or user movement in three-dimensional space.
In another embodiment, an onboard scanner captures a sample of biometric information corresponding to a scan of the user finger prints.
In another embodiment, an onboard camera captures a sample of biometric information corresponding to a scan of the user iris.
In step 124, the sample of biometric information is authenticated.
In a preferred embodiment, an onboard processor compares the sample of biometric information to a stored signature to authenticate the user.
In a preferred embodiment, a short wireless chipset is used to perform the functions of:

Short wireless communication with a second device,

Storing keys in flash and communicating them wirelessly to a second device,

Capturing a voice sample using a microphone,

Comparing the voice sample to a reference sample or reference data set, possibly using the DSP onboard the chipset.

In one embodiment, the system for authentication 10/11 stores multiple reference data sets corresponding to multiple user expressions, and identified by multiple reference codes.
When the device or interface displays on a display or plays a challenge question on a speaker, the device or interface sends a message to the system for authentication 10/11 containing a reference code corresponding to the challenge question.
The user responds by entering a voice onboard the system for authentication 10/11 or by making movements in 2D or 3D space using the system for authentication 10/11, or by scanning one of his 10 fingers, or other expression.
When a received message identifies a first reference code, the system for authentication 10/11 authenticates the captured biometric information using at a reference data set corresponding to the reference code.
If authentication is successful, the system for authentication 10/11 can send a digital key to the device or interface.
If authentication is successful, the device or interface can unlock.
If authentication is successful, access is granted.
If authentication is successful, requesting a user PIN code onboard the device or interface.
In another preferred embodiment, the system for authentication 10/11 sends the sample of biometric information to a remote server for authentication.
In another preferred embodiment, if the time period elapsed since a last successful authentication did not exceed a predetermined period of time, and if a no connection drop was detected since the last successful authentication, sending a response wirelessly to said second paired device wherein said response comprises at least one code.
In step 126, if the sample of biometric information is authenticated, access is granted, otherwise, it is denied is step 128.
In a preferred embodiment, if authentication of said user biometric information is not successful, the system for authentication 10/11 can deny access, send a message to a third person, delete all information from said unitary mobile apparatus, lock the system for authentication 10/11, wait for an unlock message, perform fourth-factor authentication.
In another preferred embodiment, the device or interface request the user to enter a PIN code or password and authenticates them prior to granting access.
It is noted that this 3-factor authentication technology presents several advantages over other 2-factor and 3-factor authentication technologies. The most important advantage is universality and ability to work in challenging environment and with challenging devices.
The system for authentication 10/11 can authenticate the user on a mobile phone (through BLUETOOTH) and provide device security (proximity alarm), automatic login, and intelligent login.
The system for authentication 10/11 can also authenticate the user to a lock that is not connected to a network (example an office door), and that has a transceiver. It can provide 2-factor as well as 3-factor authentication to that un-connected lock. If for some reason the 2-factor authentication fails, the system for authentication 10/11 may authenticate the user voice or the user movements, and possibly provide access on successful authentication of biometric factors.

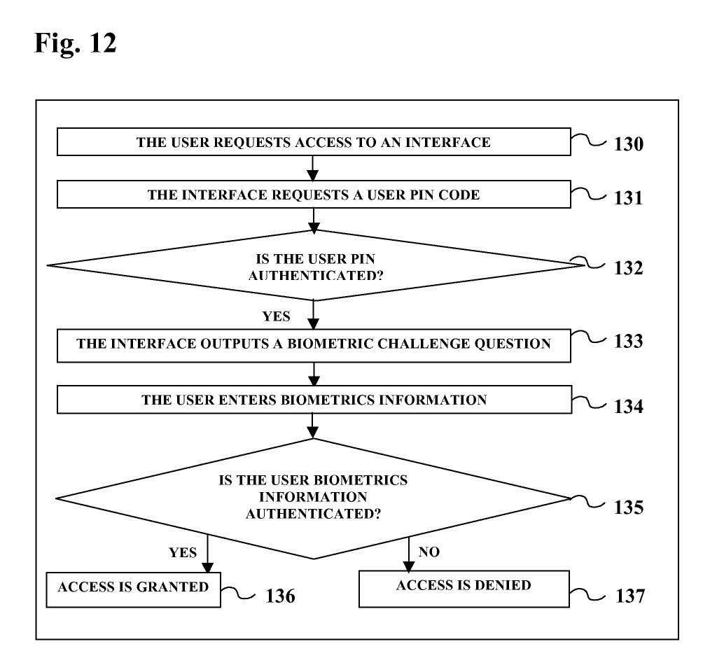

FIG. 12 is a flowchart illustrating an alternative way for three factor authentication. In step 130, the user makes a request for access to an interface, application or device and in step 131, the interface requests a user PIN code. In step 132, the user PIN code is authenticated. At that point, in step 133, the interface outputs a biometric challenge question, and sends a corresponding code to the system for authentication 10/11. The code corresponds to a set of reference information to be used to authenticate the response to the challenge question.

In a preferred embodiment, the system for authentication 10/11 stores a number of codes and a number of corresponding reference voice sets.
For example, the system for authentication 10/11 stores a first code “CODE A” and a first reference voice set corresponding to the user name in his own voice “ADAM”. When the interface displays a first challenge question: “Please say your name”, it sends a first corresponding code “CODE A” to the system for authentication 10/11.
The user uses the system for authentication 10/11 to capture her name “ADAM”.
The system for authentication 10/11 captures the biometric voice data, and compares it to the first reference voice set corresponding to the received first code. If authentication is successful, the secret code is sent. It is noted that the challenge question is a variable question that changes every time.
The interface may output a variable challenge question through visual indication center 16 or audio center 18, and the user is requested to provide a corresponding response. In a preferred embodiment, the user is requested to say something, for example, her name, city or birth or age . . . .
In step 134, the user responds to the challenge question and a microphone captures the voice response, and authenticates it in step 135.
In another preferred embodiment, the user is requested to make a hand movement in the air or on a table, corresponding to a signature, symbol or list of symbols. An onboard accelerometer or gyro captures the sensor readings corresponding to the hand movements and authenticates them.
In another embodiment, the user is requested to enter something she knows (and only she knows) from among a list of things without providing details, for example, say code #A, say code #B, say code #C, or enter signature #1, enter signature #2, or enter signature #3.
In step 135, an onboard processor compares the sample of biometric information to a stored set to authenticate the user.
In a preferred embodiment, a chipset is used to perform the functions of:
Short wireless communication with a second device,
Storing keys in memory and communicating them wirelessly to a second device, capturing a voice sample using a microphone, comparing the voice sample to a reference sample or reference data set, possibly using the DSP onboard the chipset.
In another preferred embodiment, the system for authentication 10/11 sends the sample of biometric information to a remote server for authentication.
In step 136, if the sample of biometric information is authenticated, access is granted, otherwise, it is denied is step 137.
Vouching, peer-level, or human-intermediated authentication for access control represents a fourth category of authentication <<Somebody you know>>.
This can be useful in emergency authentication, when primary authenticators like passwords or hardware tokens become unavailable, and/or when biometric authentication fails, or when a user loses her system for authentication 10/11.

Bluetooth

The BLUETOOTH specification (a de facto standard containing information required to ensure that devices supporting the protocol can communicate with each other worldwide) defines two transmission ranges for personal area networking. The range is between 10 m and 100 m without a line of sight requirement. The radio link is capable of voice and data transmission up to a maximum capacity of 720 kbps per channel. Any other range can be designed.
A short wireless network is completely self organizing, and ad hoc personal area networks (PANs) can be established wherever two or more devices supporting the protocol are sufficiently close to establish radio contact. Equipment capable of short wireless connectivity is able to self-organize by automatically searching within range for other devices. Upon establishing a contact, information is exchanged which determines if the connection should be completed or not. During this first encounter, the devices connect via a process of authorization and authentication.
Short wireless Pairing happens when two devices agree to communicate with one another. When this happens, the two devices join what is can be referred to as a trusted pair. When one device recognizes another device in an established trusted pair, each device automatically accepts communication, bypassing the discovery and authentication process that normally happen during short wireless interactions. When short wireless pairing is being set up, the following usually happens:
1. Device A (such as a handheld) searches for other short wireless enabled devices in the area.
How does A find these devices? The devices that are found all have a setting that makes them discoverable when other short wireless devices search. It's like raising your hand in a classroom: the discoverable devices are announcing their willingness to communicate with other short wireless devices. By contrast, many short wireless devices can toggle their discoverability settings off. When discoverability is off, the device will not appear when other devices search for it. Undiscoverable devices can still communicate with other short wireless devices, but they must initiate all the communications themselves.
2. Device A detects Device B (e.g. a second handheld that's discoverable).
During the discovery process, the discoverable devices usually broadcast what they are (such as a printer, a PC, a mobile phone, a handheld, etc.), and their short wireless Device Name (such as “Bob's Laptop” or “deskjet995c”). Depending on the device, you may be able to change the Device Name to something more specific. If there are 10 short wireless laptops and 5 short wireless mobile phones in range, and they are all discoverable, this can come in handy when selecting a specific device.
3. A asks B to send a Passkey or PIN
A passkey (or PIN) is a simple code shared by both devices to prove that both users agree to be part of the trusted pair. With devices that have a user interface, such as handhelds, mobile phones, and PCs, a participant must enter the passkey on the device. With other types of devices, such as printers and hands-free headsets, there is no interface for changing the passkey on the device, so the passkey is always the same (hard coded). A passkey used on most short wireless/BLUETOOTH headsets is “0000”. The passkeys from both parties must match.
4. A sends the passkey to B
Once you've entered the passkey on A, it sends that passkey to B for comparison. If B is an advanced device that needs the user to enter the same passkey, it will ask for the passkey. If not, it will simply use its standard, unchanging passkey.
5. B sends passkey back to A
If all goes well, and B's passkey is the same entered by A, a trusted pair is formed. This happens automatically when the passkeys agree. Once a trusted pair is developed, communication between the two devices should be relatively seamless, and shouldn't require the standard authentication process that occurs between two devices who are strangers. Embodiments of the present inventions take advantage of the reduced power requirements of certain short wireless/BLUETOOTH modes following pairing of two devices.

### Bluetooth has Several Types:

i) Class 2: a class 2 BLUETOOTH transceiver can discover pair and communicate with any BLUETOOTH transceiver within a radius of 10 meters seamlessly.
ii) Class 1: A class 1 BLUETOOTH transceiver can discover pair and communicate with any BLUETOOTH transceiver within a radius of 100 meters.
iii) Class 3: A class 3 BLUETOOTH transceiver can discover pair and communicate with any BLUETOOTH transceiver within a radius of 2 meters.
iv) Non standard devices: can be designed to discover pair and communicate with any BLUETOOTH transceiver within any distance less than 300 meters.

In any wireless networking setup, security is a concern. Devices can easily grab radio waves out of the air, so people who send sensitive information over a wireless connection need to take precautions to make sure those signals aren't intercepted. BLUETOOTH technology is no different—it's wireless and therefore susceptible to spying and remote access, just like WiFi is susceptible if the network isn't secure. With BLUETOOTH, though, the automatic nature of the connection, which is a huge benefit in terms of time and effort, is also a benefit to people looking to send you data without your permission.

BLUETOOTH offers several security modes, and device manufacturers determine which mode to include in a BLUETOOTH-enabled gadget. In almost all cases, BLUETOOTH users can establish “trusted devices” that can exchange data without asking permission. When any other device tries to establish a connection to the user's gadget, the user has to decide to allow it. Service-level security and device-level security work together to protect BLUETOOTH devices from unauthorized data transmission. Security methods include authorization and identification procedures that limit the use of BLUETOOTH services to the registered user and require that users make a conscious decision to open a file or accept a data transfer. As long as these measures are enabled on the user's phone or other device, unauthorized access is unlikely. A user can also simply switch his BLUETOOTH mode to “non-discoverable” and avoid connecting with other BLUETOOTH devices entirely. If a user makes use of the BLUETOOTH network primarily for synching devices at home, this might be a good way to avoid any chance of a security breach while in public.
In the current application, once system for authentication 10/11 is paired, it becomes “non-discoverable”. Also, to further avoid any chance of a security breach, system for authentication 10/11 does not have a reset button or reset function.
If reset is needed, an administrator may flash a new program file to system for authentication 10/11 thus re-enabling the pairing capability. This feature is important as it prevents anybody from hacking the device or learning how it functions, or what protocols it uses.
BLUETOOTH Wireless Technology Profiles: In order to use BLUETOOTH wireless technology, a device must be able to interpret certain BLUETOOTH profiles. The profiles define the possible applications. BLUETOOTH profiles are general behaviors through which BLUETOOTH enabled devices communicate with other devices. BLUETOOTH technology defines a wide range of profiles:
Hands-Free Profile (HFP). Headset Profile (HSP), Serial Port Profile (SPP), DUN, FAX, HSP and LAN profiles, Human Interface Device Profile (HID), Advanced Audio Distribution Profile (A2DP), Audio/Video Control Transport Protocol (AVCTP), Audio/Video Distribution Transport Protocol (AVDTP), Audio/Video Remote Control Profile (AVRCP). Apple uses a proprietary protocol similar to SPP called iAP. Moreover, NFC or RFID can be used. These protocols can be run one at a time, or in parallel. In sniff mode, a device listens only periodically during specific sniff slots, but retains synchronization with the paired BLUETOOTH device onboard the monitored device. In other embodiments, short wireless system 20 can use BLUETOOTH hold mode wherein a device listens only to determine if it should become active, or park mode wherein a device transmits its address. Sniff mode assures very low power consumption and thus extends battery life.
In sniff mode, a BLUETOOTH master radio frequency unit (e.g., base) addresses a slave radio frequency unit (e.g., remote), which enables the slave to synchronize to the master by sending poll packets and optionally null packets over an active link, the master being arranged so that receipt of a response from the slave unit to a poll packet is sufficient to maintain the active link. The slave unit does not have to respond to all poll packets. This approach can allow the slave to preserve more (transmit) power by going into a deep sleep mode in which a low power oscillator may be used while still allowing the master unit to detect whether the slave has resynchronized or not (and thus to update a Link Supervision Timer, for example).

The details of certain embodiments of the present inventions have been described, which are provided as illustrative examples so as to enable those of ordinary skill in the art to practice the inventions. The summary, figures, abstract and further details provided are not meant to limit the scope of the present inventions, but to be exemplary. Where certain elements of the present inventions can be partially or fully implemented using known components, only those portions of such known components that are necessary for an understanding of the present invention are described, and detailed descriptions of other portions of such known components are omitted so as to avoid obscuring the invention. Further, the present invention encompasses present and future known equivalents to the components referred to herein.

The inventions are capable of other embodiments and of being practiced and carried out in various ways, and as such, those skilled in the art will appreciate that the conception upon which this disclosure is based may readily be utilized as a basis for the designing of other methods and systems for carrying out the several purposes of the present inventions. Therefore, the claims should be regarded as including all equivalent constructions insofar as they do not depart from the spirit and scope of the present invention. The following claims are a part of the detailed description of the invention and should be treated as being included in this specification.

1. A method for mobile security comprising:
a computer terminal establishing a short wireless connection with a paired unitary mobile apparatus,
wherein said unitary mobile apparatus has a volume smaller than 30 cm3, a memory smaller than 100 Mega Bytes, and does not have an LCD larger than 3 cm2;
wherein upon said computer terminal sending at least one digital code wirelessly to said paired unitary mobile apparatus using a data communication protocol selected from the group consisting of: Serial Port Profile (SPP), iPod Accessory Protocol (iAP) and NFC, wherein said at least one digital code indicating to activate proximity monitoring,
said unitary mobile apparatus monitors proximity to said computer terminal using a communication protocol selected from the group consisting of: Hands Free Profile (HFP), Headset Profile (HSP), Human Interface Device Profile (HID), Advanced Audio Distribution Profile (A2DP),
wherein upon detection of an event selected from the group consisting of:
said short wireless connection dropped due to a loss of signal,
said short wireless connection has signal strength that is below a predetermined threshold,
said unitary mobile apparatus performs actions selected from the group consisting of:
issuing an audible alert and issuing a vibration indication;
wherein upon said computer terminal sending at least one digital code wirelessly to said paired unitary mobile apparatus, wherein said at least one digital code indicating to deactivate proximity monitoring, said unitary mobile apparatus stops indicating events corresponding to loss of proximity.

2. The method of claim 1 wherein:
upon said computer terminal detecting a user entering a geographical area selected from the group consisting of:
a predetermined geographical area, a range around a location, a distance away from a location,
said computer terminal sends at least one digital code wirelessly to said paired unitary mobile apparatus indicating to activate or to deactivate proximity monitoring.

3. The method of claim 1 wherein:
upon said computer terminal detecting movement using at least one means onboard said computer terminal selected from the group consisting of: motion detection means, accelerometer, gyroscope, GPS determination means, AGPS determination means, GLONASS determination means,
wherein said computer terminal captures current location information using at least one location determination means onboard said computer terminal and compares the current location information to at least one trusted location information,
wherein said at least one trusted location information is stored onboard said computer terminal and corresponds to at least one trusted physical location;
wherein upon detecting that the current location information is more than a predetermined distance away from trusted location information stored onboard said computer terminal,
sending at least one digital code wirelessly to said paired unitary mobile apparatus, wherein said at least one digital code indicates a request to activate proximity monitoring;
wherein upon detecting that the current location information is less than a predetermined distance away from at least one trusted location information stored onboard said computer terminal,
sending at least one digital code wirelessly to said paired unitary mobile apparatus, wherein said at least one digital code indicates to stop proximity monitoring.

4. The method of claim 3 wherein:
upon said computer terminal receiving at least one digital code from said unitary mobile apparatus, wherein said at least one digital code indicating an alert condition, said computer terminal performs actions selected from the group consisting of:
issuing an audible alert, issuing a vibration indication, closing a document, closing a connection to a server.

5. The method of claim 3 wherein:
upon said computer terminal detecting an event selected from the group consisting of:
said short wireless connection dropped due to a loss of signal,
said short wireless connection has signal strength below a predetermined threshold,
said computer terminal performs actions selected from the group consisting of:
issuing an audible alert, issuing a vibration indication, closing a document, closing a connection to a server.

6. The method of claim 1 wherein:
upon said computer terminal sending at least one digital code wirelessly to said paired unitary mobile apparatus, wherein said at least one digital code indicates a request to change to discoverable mode, said unitary mobile apparatus changes to discoverable;
and wherein upon said computer terminal sending at least one digital code wirelessly to said paired unitary mobile apparatus, wherein said at least one digital code indicates a request to change to non-discoverable mode, said unitary mobile apparatus changes to non-discoverable.

7. The method of claim 1 wherein:
upon said computer terminal sending at least one digital code wirelessly to said paired unitary mobile apparatus, wherein said at least one digital code indicates a request to send at least one user digital key,
said paired unitary mobile apparatus obtains motion information from at least one onboard motion detection means,
said paired unitary mobile apparatus determines if motion is detected,
if motion is not detected, said paired unitary mobile apparatus sends at least one user digital key to said computer terminal.

8. The method of claim 1 wherein:
upon said computer terminal sending at least one digital code wirelessly to said paired unitary mobile apparatus, wherein said at least one digital code indicating a request to send a user digital key, and wherein said at least one digital code comprises a newly generated one-time password,
said paired unitary mobile apparatus authenticates said one-time password, and if said one-time password is valid, sends a wireless response to said computer terminal.

9. The method of claim 1 wherein:
upon said computer terminal sending at least one digital code wirelessly to said paired unitary mobile apparatus, wherein said at least one digital code indicates performing a biometric authentication, wherein said at least one digital code comprises at least one key,
capturing user biometric information using at least one onboard biometric sensor means,
comparing said user biometric information to at least one set of reference user biometric information corresponding to said at least one key;
wherein upon successful authentication, sending an indication to said paired computer terminal.

10. The method of claim 1 wherein:
upon said computer terminal receiving a user request for access,
if the time period elapsed since a last successful user authentication did not exceed a predetermined period of time,
and if a connection drop was not detected since the last successful user authentication,
sending at least one digital code wirelessly to said computer terminal.

11. A unitary mobile apparatus for providing user authentication information comprising:
a single short wireless transceiver, wherein said short wireless transceiver is selected from the group consisting of: Bluetooth, Wibree, NFC, ANT, Wi-Fi;
an onboard memory for storing at least one user key;
an onboard motion detector means for determining if the user is moving;
wherein said unitary mobile apparatus establishes a short wireless connection with a paired computer terminal within proximity;
wherein upon receipt of a wireless request for a user digital key from said paired computer terminal within proximity, performing actions selected from the group consisting of:
verifying that the user is not moving using said onboard motion detector means, and verifying that the user motion patterns from said onboard motion detector means has a high correlation with a predetermined idle motion pattern;
if the user is not moving, sending the at least one user digital key from memory to said paired computer terminal wirelessly,
if the user is moving, said unitary mobile apparatus does not send a response;
wherein said unitary mobile apparatus has a volume smaller than 30 cm3, has a memory smaller than 100 Mega Bytes, and does not have a display larger than 3 CM2.

12. The unitary mobile apparatus of claim 11 further comprising:
an onboard means for generating sound, wherein upon detection of an event selected from the group consisting of:
said short wireless connection dropped due to a loss of signal,
said short wireless connection has signal strength below a predetermined threshold,
performing actions selected from the group consisting of:
issuing an audible alert and issuing a vibration indication.

13. The unitary mobile apparatus of claim 12 wherein upon receipt of a wireless request indicating to deactivate alerting, said unitary mobile apparatus stops issuing audible alerts.

14. The unitary mobile apparatus of claim 11 wherein upon receipt of a wireless request indicating to change mode to discoverable mode, said unitary mobile apparatus changes to discoverable.

15. The unitary mobile apparatus of claim 11 further comprising at least one onboard biometric sensor means;
wherein upon receipt of a wireless request indicating to perform biometric authentication,
wherein said wireless request comprises at least one digital code,
said unitary mobile apparatus captures a sample of biometric information from a user using said at least one onboard biometric sensor means, wherein said biometric information is selected from the group consisting of:
voice, movement in two-dimensional space, movement in three-dimensional space, a fingerprint, a finger vein scan, and an iris scan;
wherein said sample of biometric information is compared to at least one set of reference biometric information for said user corresponding to said at least one digital code;
wherein upon successful authentication, sending at least one digital message to said paired computer terminal.

16. The unitary mobile apparatus of claim 11 further comprising a speaker means selected from the group consisting of:
a wire speaker and,
an earpiece movable relative to the body of said unitary mobile apparatus.

17. The unitary mobile apparatus of claim 11 further comprising an onboard means selected from the group consisting of:
a cryptographic chipset for performing cryptographic functions,
an encryption chipset for performing encryption functions,
a secure element (SE) for providing secure data storage.

18. The unitary mobile apparatus of claim 11 further comprising an onboard antenna selected from the group consisting of:
an NFC antenna for communicating with payment terminals,
an RFID antenna for communicating with RFID terminals.

19. A method for security comprising:
a unitary mobile apparatus establishing a short wireless connection with a paired computer terminal,
wherein said unitary mobile apparatus has a volume smaller than 30 cm3, a memory smaller than 100 Mega Bytes, and does not have an LCD larger than 3 cm2;
wherein upon said unitary mobile apparatus receiving at least one digital code wirelessly from said paired computer terminal, and wherein said at least one digital code indicating a request to change to discoverable mode,
said unitary mobile apparatus changes to discoverable;
wherein upon said unitary mobile apparatus receiving at least one digital code wirelessly from said computer terminal, wherein said at least one digital code indicating a request to activate proximity monitoring,
said unitary mobile apparatus monitors proximity to said computer terminal and upon detection of an event selected from the group consisting of:
said short wireless connection dropped due to a loss of signal,
said short wireless connection has signal strength that is below a predetermined threshold,
said unitary mobile apparatus performs actions selected from the group consisting of:
issuing an audible alert and issuing a vibration indication;
wherein upon said unitary mobile apparatus receiving at least one digital code wirelessly from said computer terminal wherein said at least one digital code indicating a request to send at least one user digital key,
said unitary mobile apparatus verifies that the user is not moving using at least one onboard motion detection means, and only if the user is not moving, sends a wireless response to said computer terminal;
wherein said unitary mobile apparatus uses a data communication protocol selected from the group consisting of: Serial Port Profile (SPP), iPod Accessory Protocol (iAP) and NFC to send said digital code,
wherein said unitary mobile apparatus uses a communication protocol selected from the group consisting of: Hands Free Profile (HFP), Headset Profile (HSP), Human Interface Device Profile (HID), Advanced Audio Distribution Profile (A2DP) to monitor proximity to said computer terminal.

20. The method of claim 19 wherein:
upon receipt of a user indication, sending a user key to said computer terminal.
